(19) United States
(12) Patent Application Publication
(10) Pub. No.: US 2014/0210711 A1
(43) Pub. Date: Jul. 31, 2014

(54) TOUCH PANEL AND TOUCH APPARATUS

(71) Applicant: KYE SYSTEMS CORP., New Taipei (TW)

(72) Inventor: Chih-Min LIU, New Taipei (TW)

(73) Assignee: KYE SYSTEMS CORP., New Taipei (TW)

(21) Appl. No.: 14/036,118

(22) Filed: Sep. 25, 2013

(30) Foreign Application Priority Data
Jan. 30, 2013 (TW) 102103580

(51) Int. Cl. G06F 3/0354

(52) U.S. Cl. CPC G06F 3/0354
USPC 345/157

(57) ABSTRACT

A touch panel, suitable for sensing a battery-free wireless cursor component, includes a display unit, a touch unit, a processor unit, and an antenna unit. The display unit has a first side and a second side opposite the first side. The touch unit, disposed on the first side of the display unit, receives a cursor signal generated by the battery-free wireless cursor component to generate a touch signal. The processor unit, coupled with the touch unit, receives the touch signal, calculates coordinates of the battery-free wireless cursor component based on the received touch signal, and generates a control signal based on the calculated coordinates. The antenna unit, disposed on the second side of the display unit and coupled with the processor unit, receives the control signal and transmits a frequency signal based on the control signal.

### CROSS-REFERENCE TO RELATED APPLICATIONS

This non-provisional application claims priority under 35 U.S.C. §119(a) on Patent Application No. 102103580 filed in Taiwan, R.O.C. on Jan. 30, 2013, the entire contents of which are hereby incorporated by reference.

### TECHNICAL FIELD

This disclosure relates to a touch-operated device, particularly to a touch panel and a touch apparatus with a battery-free wireless cursor component.

### BACKGROUND

Commercial touch panels are commonly used with wireless cursor components. When a wireless cursor component touches a touch panel, it generates an electromagnetic field, enabling the touch panel to derive through magnetic coupling the wireless cursor component's current position, which is then sent to a computer by the touch panel.

For wireless cursor components to work, the power necessary is usually supplied by either primary cells or electromagnetic resonance. Primary cells powering a wireless cursor component need frequent replacement, a requirement which is neither environmental- nor user-friendly. In addition, the existence of primary cells increases the size and cost of a wireless cursor component.

In contrast, electromagnetic resonance is more suitable as a power-supplying means. Nevertheless, some touch panels include sensors using indium tin oxide (ITO), which has high electrical impedance and may not be suitable for energy transfer. It is therefore difficult for a wireless cursor component operating on an ITO-based touch panel to be effectively powered by electromagnetic resonance, leaving room for technological advancement.

### SUMMARY

The present invention provides a touch panel and a touch apparatus. By making a wireless cursor component free of batteries, the size of the wireless cursor component is reduced, facilitating convenience of use.

The present invention discloses a touch panel, which is suitable for sensing a battery-free wireless cursor component. The touch panel includes a display unit, a touch unit, a processor unit, and an antenna unit. The display unit has a first side and a second side opposite the first side. The touch unit, disposed on the first side of the display unit, receives a cursor signal generated by the battery-free wireless cursor component to generate a touch signal. The processor unit, coupled with the touch unit, receives the touch signal, calculates coordinates of the battery-free wireless cursor component based on the received touch signal, and generates a control signal based on the calculated coordinates. The antenna unit, disposed on the second side of the display unit and coupled with the processor unit, receives the control signal and transmits a frequency signal based on the control signal.

In one embodiment, the said touch unit is made of indium tin oxide.

In one embodiment, the said antenna unit includes antenna loops. The antenna loops transmit the frequency signal. The processor unit directs at least one of the antenna loops to transmit the frequency signal based on the coordinates.

In one embodiment, the said antenna unit is formed by superimposing a first edge of one of the antenna loops at least partially over a second edge of another of the antenna loops, or by juxtaposing the first edge and the second edge.

In one embodiment, the said antenna unit is smaller in area than the display unit.

The present invention also discloses a touch apparatus, which includes a touch panel and a battery-free wireless cursor component. The touch panel includes a display unit, a touch unit, a processor unit, and an antenna unit. The display unit has a first side and a second side opposite the first side. The touch unit, disposed on the first side of the display unit, receives a cursor signal generated by the battery-free wireless cursor component to generate a touch signal. The processor unit, coupled with the touch unit, receives the touch signal, calculates coordinates of the battery-free wireless cursor component based on the received touch signal, and generates a control signal based on the calculated coordinates. The antenna unit, disposed on the second side of the display unit and coupled with the processor unit, receives the control signal and transmits a frequency signal based on the control signal. The battery-free wireless cursor component includes a power supply unit and a cursor unit. The power supply unit receives the frequency signal to generate a power signal. The cursor unit receives the power signal to generate the cursor signal, and transmits the cursor signal to the touch unit.

In one embodiment, the said touch unit is made of indium tin oxide.

In one embodiment, the said antenna unit includes antenna loops. The antenna loops transmit the frequency signal. The processor unit directs at least one of the antenna loops to transmit the frequency signal based on the coordinates.

In one embodiment, the said antenna unit is formed by superimposing a first edge of one of the antenna loops at least partially over a second edge of another of the antenna loops, or by juxtaposing the first edge and the second edge.

In one embodiment, the said antenna unit is smaller in area than the display unit.

With regard to the touch panel and the touch apparatus disclosed by the present invention, the touch unit is disposed on the first side of the display unit of the touch panel, the antenna unit is disposed on the second side of the display unit opposite the first side, the touch unit senses the battery-free wireless cursor component, and the touched coordinates of the battery-free wireless cursor component is obtained through calculation by the processor unit, which generates the control signal to direct the antenna unit to generate the frequency signal for the battery-free wireless cursor component, so as to supply the necessary power for the battery-free wireless cursor component to work. In addition, the antenna unit includes the antenna loops, the processor unit selectively directs the antenna loops to generate the frequency signal, and the antenna unit may be smaller in area than the display unit. Accordingly, the size of the battery-free wireless cursor component and the layout area of the antenna unit are reduced, facilitating convenience of use.

### BRIEF DESCRIPTION OF THE DRAWINGS

The present disclosure will become more fully understood from the detailed description given herein below for illustration only, and thus does not limit the present disclosure, wherein:

FIG. 1 is a circuit block diagram of a touch apparatus, in accordance with an embodiment of the present invention.

FIG. 2 is a stereoscopic diagram of a touch apparatus, in accordance with an embodiment of the present invention.

FIG. 3 illustrates an arrangement of the antenna loops of an antenna unit, in accordance with an embodiment of the present invention.

FIG. 4 illustrates another arrangement of the antenna loops of an antenna unit, in accordance with an embodiment of the present invention.

FIG. 5 illustrates a disposition of a display unit and an antenna unit, in accordance with an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The same symbol applies to the same or similar components in the embodiments enumerated below.

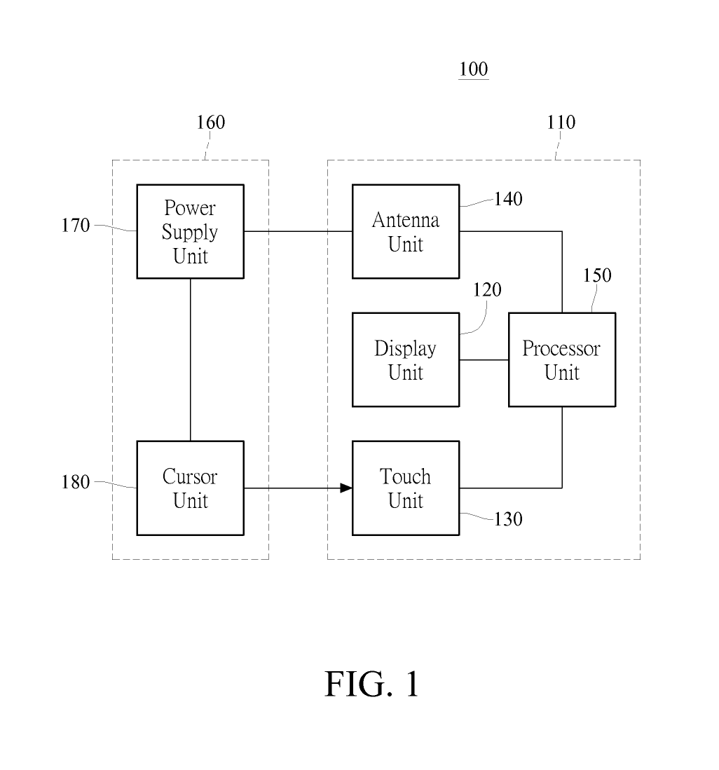

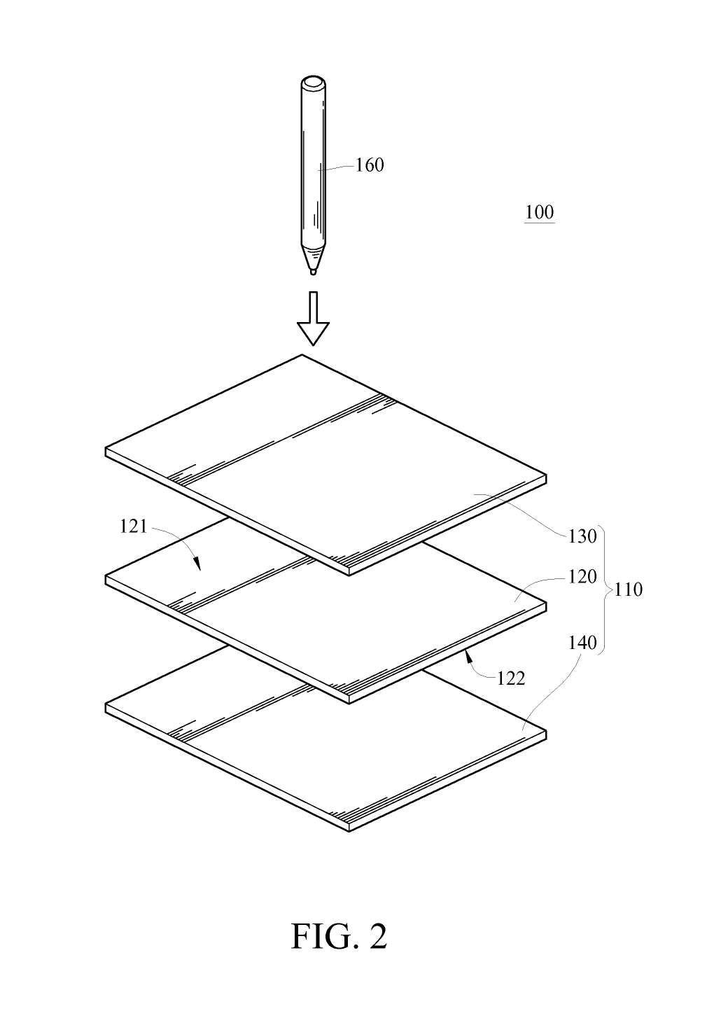

FIG. 1 is a circuit block diagram of the touch apparatus disclosed by the present invention, whereas FIG. 2 is a stereoscopic diagram of the said touch apparatus. The touch apparatus 100 includes a touch panel 110 and a battery-free wireless cursor component 160, hereafter referred to as the cursor component. The touch panel 110 may be a peripheral device having an electromagnetic touch panel, such as a handwriting pad or a drawing tablet. The cursor component 160 may be an electromagnetic stylus for operating the touch panel 110.

The touch panel 110 includes a display unit 120, a touch unit 130, an antenna unit 140, and a processor unit 150. The display unit 120, having a first side 121 and a second side 122 opposite the first side 121, displays a corresponding operation on the touch panel 110.

The touch unit 130, disposed on the first side 121 of the display unit 120, receives a cursor signal generated by the cursor component 160 to generate a touch signal. The touch unit 130 constitutes a sensing zone for sensing the cursor component 160; when the cursor component 160 touches the touch unit 130, the touch unit 130 may sense the cursor signal generated by the cursor component 160 and generates the corresponding touch signal. In one embodiment, the touch unit 130 is made of indium tin oxide.

The processor unit 150, coupled with the touch unit 130, receives the touch signal and calculates coordinates of the cursor component 160 based on the received touch signal. The processor unit 150 also generates a control signal for the antenna unit 140 based on the calculated coordinates. Furthermore, the processor unit 150 is coupled with the display unit 120 to send to the display unit 120 a process status signal corresponding to the touch signal for displaying the corresponding operation on the display unit 120.

The antenna unit 140, disposed on the second side 122 of the display unit 120 and coupled with the processor unit 150, receives the control signal, transforms the received control signal into a frequency signal, and transmits the frequency signal. In other words, the antenna unit 140, triggered by the control signal, transforms the control signal into the corresponding frequency signal, and transmits the frequency signal to the cursor component 160, so as to supply the necessary power for the cursor component 160 to work.

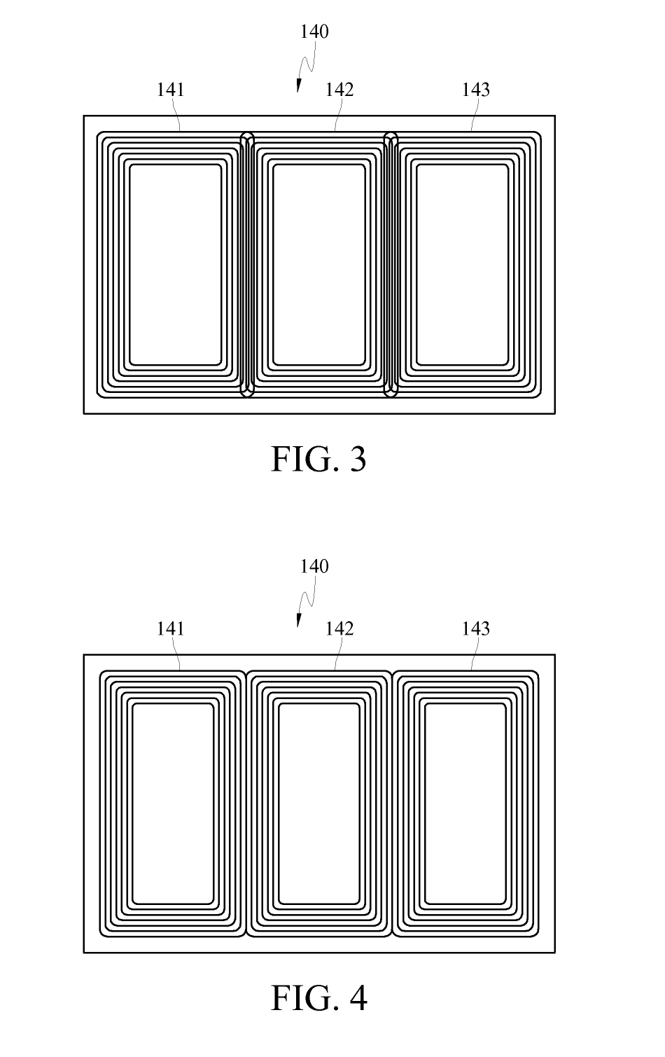

In one embodiment, the antenna unit 140 includes antenna loops 141, 142, and 143 for transmitting the frequency signal. In one embodiment, the adjacent antenna loops 141 and 142 partially overlap; that is, one edge of one of the antenna loops is overlaid in part on another edge of the other antenna loop, as shown in FIG. 3, where the same can also be said of the adjacent antenna loops 142 and 143. In another embodiment, the adjacent antenna loops 141 and 142 do not overlap; that is, their edges adjoin, as shown in FIG. 4, where the same can also be said of the adjacent antenna loops 142 and 143.

Only three antenna loops are depicted in FIGS. 3 and 4, but the present invention does not limit the number of antenna loops. In other embodiments, there may be two, four, or more than four antenna loops.

The processor unit 150 may selectively generate the control signal for at least one of the antenna loops 141, 142, and 143 based on the coordinates it calculated, in order to direct at least one of the antenna loops 141, 142, and 143 to generate the frequency signal. For example, when the cursor component 160 touches the touch unit 130 and is located above the antenna loop 141, the processor unit 150 may calculate and obtain coordinates of the cursor component 160 based on the touch signal generated by the touch unit 130. The coordinates are then used to generate the control signal for the antenna loop 141, in order to direct the antenna loop 141 to transmit the frequency signal. On the other hand, the antenna loops 142 and 143 are not enabled to transmit the frequency signal because the antenna loops 142 and 143 are not provided with the control signal by the processor unit 150. As such, by selectively directing the corresponding antenna loops to generate the frequency signal for the cursor component 160, energy consumption is reduced.

In another embodiment, the processor unit 150 may simultaneously generate the control signal for several adjacent antenna loops. For example, the processor unit 150 may generate the control signal for both antenna loops 141 and 142, in order to select and direct the antenna loops 141 and 142 to transmit the frequency signal. Alternatively, the processor unit 150 may simultaneously generate the control signal for the antenna loops 142 and 143, in order to select and direct the antenna loops 142 and 143 to transmit the frequency signal.

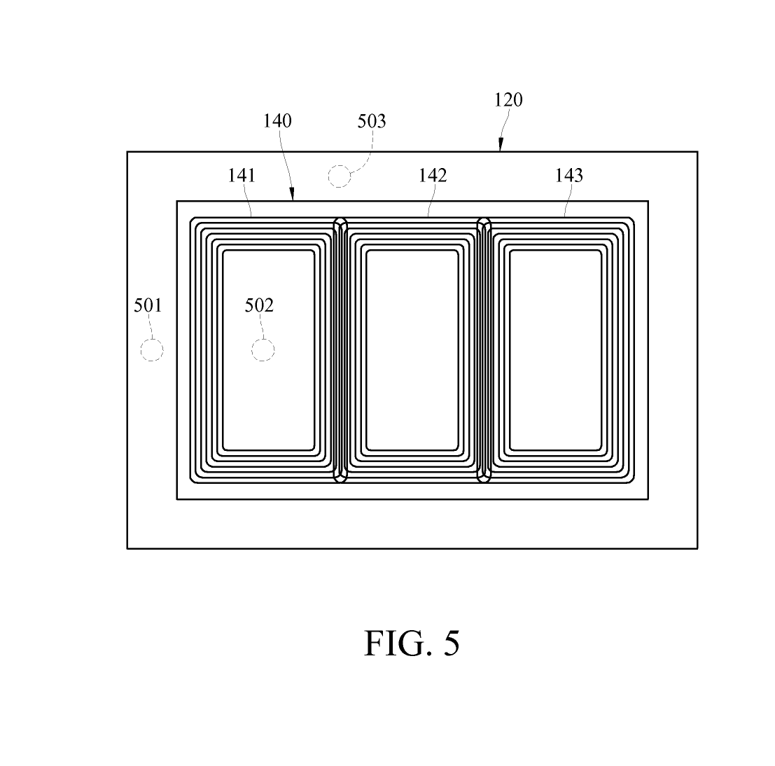

In one embodiment, the area of the antenna unit 140 may be designed to be smaller than that of the display unit 120, as shown in FIG. 5, while the function of the touch panel 110 to supply the necessary power for the cursor component 160 to work is kept. Moreover, the touch unit 130 may have the same area as the display unit 120; that is, the area of the antenna unit 140 is also smaller than that of the sensing zone constituted by the touch unit 130. Consequently, when the cursor component 160 touches the touch unit 130, the cursor component 160 may be located close to the antenna unit 140 (e.g. the touch points 501 or 503 in FIG. 5) but not directly above the antenna unit 140 (e.g. the touch point 502 in FIG. 5).

For example, when the cursor component 160 touches the touch unit 130 and is located close to the antenna loop 141 (e.g. the touch point 501 in FIG. 5), the processor unit 150 may calculate and obtain coordinates of the cursor component 160 based on the touch signal generated by the touch unit 130. The coordinates are then used to generate the control signal for the antenna loop 141, in order to direct the antenna loop 141 to transmit the frequency signal. Meanwhile, the antenna loops 142 and 143 are not enabled to transmit the frequency signal because the antenna loops 142 and 143 are not provided with the control signal by the processor unit 150.

In another example, when the cursor component 160 touches the touch unit 130 and is located close to both of the adjacent antenna loops 141 and 142 (e.g. the touch point 503 in FIG. 5), the processor unit 150 may generate the control signal for both antenna loops 141 and 142, in order to direct the antenna loops 141 and 142 to transmit the frequency signal.

In another example, when the cursor component 160 touches the touch unit 130 and is located above the antenna loop 141 (e.g. the touch point 502 in FIG. 5), the processor unit 150 may generate the control signal for the antenna loop 141, in order to direct the antenna loop 141 to transmit the frequency signal. Meanwhile, the antenna loops 142 and 143 are not enabled to transmit the frequency signal because the antenna loops 142 and 143 are not provided with the control signal by the processor unit 150.

In another example, when the cursor component 160 touches the touch unit 130 and is located above the antenna loop 141 (e.g. the touch point 502 in FIG. 5), the processor unit 150 may generate the control signal for both antenna loops 141 and 142, in order to direct the antenna loops 141 and 142 to transmit the frequency signal.

In FIG. 5, the antenna loops 141, 142, and 143 of the antenna unit 140 are depicted as similar to those in FIG. 3, but the present invention also allows the antenna loops 141, 142, and 143 in FIG. 5 to be arranged as in FIG. 4.

The cursor component 160 includes a power supply unit 170 and a cursor unit 180. The power supply unit 170 receives the frequency signal to generate a power signal. In particular, the power supply unit 170 may include induction coils and a rectifier circuit. The induction coils may simultaneously receive the frequency signal transmitted by the antenna unit 140 and become in tune with each other, causing an electromagnetic resonance effect and generating an energy signal to the rectifier circuit. The rectifier circuit then generates the power signal using the energy signal to supply the necessary power for the cursor component 160 to work.

The cursor unit 180 receives the power signal to generate the cursor signal, and transmits the cursor signal to the touch unit 130. In particular, the cursor unit 180 may include an oscillator circuit and an induction coil. The oscillator circuit, whose operation is supplied by the power signal generated by the power supply unit 170, generates the cursor signal. The induction coil then transmits the cursor signal generated by the oscillator circuit to the touch unit 130.

The antenna unit 140 of the touch panel 110 transmits the frequency signal to the cursor component 160 to supply the necessary power for the cursor component 160 to work, enabling the cursor component 160 to operate on the touch panel 110. Because the cursor component 160 is battery-free, the size of the cursor component 160 is reduced.

With regard to the touch panel and the touch apparatus disclosed by the present invention, the touch unit is disposed on the first side of the display unit of the touch panel, the antenna unit is disposed on the second side of the display unit opposite the first side, the touch unit senses the battery-free wireless cursor component, and the touched coordinates of the battery-free wireless cursor component is obtained through calculation by the processor unit, which generates the control signal to direct the antenna unit to generate the frequency signal for the battery-free wireless cursor component, so as to supply the necessary power for the battery-free wireless cursor component to work. In addition, the antenna unit includes the antenna loops, the processor unit selectively directs the antenna loops to generate the frequency signal, and the antenna unit may be smaller in area than the display unit. Accordingly, the size of the battery-free wireless cursor component and the layout area of the antenna unit are reduced, facilitating convenience of use.

What is claimed is:

1. A touch panel, suitable for sensing a battery-free wireless cursor component, comprising:
a display unit having a first side and a second side opposite the first side;
a touch unit, disposed on the first side of the display unit, for receiving a cursor signal generated by the battery-free wireless cursor component to generate a touch signal;
a processor unit, coupled with the touch unit, for receiving the touch signal, calculating coordinates of the battery-free wireless cursor component based on the received touch signal, and generating a control signal based on the calculated coordinates; and
an antenna unit, disposed on the second side of the display unit and coupled with the processor unit, for receiving the control signal and transmitting a frequency signal based on the control signal.

2. The touch panel of claim 1, wherein the touch unit is made of indium tin oxide.

3. The touch panel of claim 1, wherein the antenna unit includes antenna loops which transmit the frequency signal and the processor unit directs at least one of the antenna loops to transmit the frequency signal based on the coordinates.

4. The touch panel of claim 3, wherein the antenna unit is formed by superimposing a first edge of one of the antenna loops at least partially over a second edge of another of the antenna loops, or by juxtaposing the first edge and the second edge.

5. The touch panel of claim 1, wherein the antenna unit is smaller in area than the display unit.

6. A touch apparatus, comprising
a battery-free wireless cursor component, comprising:
a power supply unit, for receiving a frequency signal to generate a power signal; and
a cursor unit, for receiving the power signal to generate and transmit a cursor signal; and
a touch panel, comprising:
a display unit having a first side and a second side opposite the first side;
a touch unit, disposed on the first side of the display unit, for receiving a cursor signal generated by the battery-free wireless cursor component to generate a touch signal;
a processor unit, coupled with the touch unit, for receiving the touch signal, calculating coordinates of the battery-free wireless cursor component based on the received touch signal, and generating a control signal based on the calculated coordinates; and
an antenna unit, disposed on the second side of the display unit and coupled with the processor unit, for receiving the control signal and transmitting a frequency signal based on the control signal.

7. The touch apparatus of claim 6, wherein the touch unit is made of indium tin oxide.

8. The touch apparatus of claim 6, wherein the antenna unit includes antenna loops which transmit the frequency signal and the processor unit directs at least one of the antenna loops to transmit the frequency signal based on the coordinates.

9. The touch apparatus of claim 8, wherein the antenna unit is formed by superimposing a first edge of one of the antenna loops at least partially over a second edge of another of the antenna loops, or by juxtaposing the first edge and the second edge.

10. The touch apparatus of claim 6, wherein the antenna unit is smaller in area than the display unit.
